(19) United States
(12) Patent Application Publication
(10) Pub. No.: US 2026/0162915 A1
(43) Pub. Date: Jun. 11, 2026

(54) SYSTEM AND METHOD FOR PROTECTING ELECTROMECHANICAL SWITCHGEAR

(71) Applicant: LEACH INTERNATIONAL CORPORATION, Buena Park, CA (US)

(72) Inventors: Tony Hana, Anaheim, CA (US); Imtiaz Ahmad Khan, Trabuco Canyon, CA (US); Anhtai Le Tran, Garden Grove, CA (US)

(21) Appl. No.: 18/972,645

(22) Filed: Dec. 6, 2024

(51) Int. Cl. H01H 9/38; H01H 9/02; H01H 9/54

(52) U.S. Cl. CPC H01H 9/38; H01H 9/0271; H01H 9/548

(57) ABSTRACT

A switching system includes: an electromechanical switchgear including main contacts and auxiliary contacts, the main contacts being coupled between a first terminal of the switching system and a second terminal of the switching system and configured to selectively open or close in response to a control signal; and a solid-state switch electrically connected in series with the auxiliary contacts to form a solid-state-auxiliary pair, the solid-state-auxiliary pair being coupled between the first terminal and a second moveable contact of the main contacts.

### FIELD

Aspects of embodiments of the present disclosure are generally related to electromechanical switchgears.

### BACKGROUND

Switchgears are commonly used for controlling and switching on or off electrical circuits in electrical power systems. Examples of switchgear devices may include electromechanical switches/relays, fuses, circuit breakers, isolators, current and potential transformers, etc.

Electromechanical switchgears are generally designed to operate at a certain voltage. They can be permanently damaged when subjected to a voltage higher than their normal rating. The damage is often caused by arcing and fretting of contact material, and may eventually lead to catastrophic failure due to sustained arcing.

In high-voltage applications, an electric arc may occur when current-carrying contacts of a switch/relay are separated (i.e., when contacts are opened under load). When the voltage across the contacts is sufficiently high, the air molecules across the gap between the separating contacts may ionize. The generated plasma may have a low enough electrical resistance to sustain electron flow even with the separation distance between the contacts steadily increasing. The resulting electrical discharge is known as an electric arc. This arcing may cause the contact material to vaporize and/or or transfer from one side to the other side, leading to deterioration and fretting of the contacts, which in turn substantially reduce the life of a switchgear.

Electronics may be used to reduce the fretting damage caused by arcing to the contacts of electromechanical switchgear. This technique is more prevalent in high voltage applications, where the arc is more severe and longer duration, reducing the life of the electromechanical switchgear. As described above, most of the damage to the contact material occurs during opening.

The above information disclosed in this Background section is only for enhancement of understanding of the present disclosure, and therefore it may contain information that does not form the prior art that is already known to a person of ordinary skill in the art.

### SUMMARY

Aspects of embodiments of the present disclosure are directed to a system for protecting electromechanical switchgears against high voltage arcs that may occur in high voltage applications. In some embodiments, a high-voltage electromechanical switching protection system utilizes a power semiconductor for limiting the voltage across a switchgear or a protection system, thus effectively increasing the power-rating of the switching protection system.

According to some embodiments of the present disclosure, there is provided a switching system including: an electromechanical switchgear including main contacts and auxiliary contacts, the main contacts being coupled between a first terminal of the switching system and a second terminal of the switching system and configured to selectively open or close in response to a control signal; and a solid-state switch electrically connected in series with the auxiliary contacts to form a solid-state-auxiliary pair, the solid-state-auxiliary pair being coupled between the first terminal and a second moveable contact of the main contacts.

In some embodiments, the solid-state switch includes drain, source, and gate electrodes.

In some embodiments, the auxiliary contacts are configured to open after a period of time in response to opening of the main contacts.

In some embodiments, the period of time is about 100 μs and 3 ms.

In some embodiments, the auxiliary contacts are coupled to the main contacts and are configured to close before closing of the main contacts.

In some embodiments, a gate of the solid-state switch is electrically connected to the second moveable contact of the main contacts.

In some embodiments, the first terminal is coupled to a power source, and the second terminal is coupled to a load circuit.

In some embodiments, the main contacts include: a first stationary contact coupled to the first terminal; a second stationary contact coupled to the second terminal; a first moveable contact and a second moveable contact; a moveable arm fixedly coupling the first and second moveable contacts and configured to move in response to the control signal.

In some embodiments, the first moveable contact and the second moveable contact are configured to contact the first stationary contact and the second stationary contact, respectively, in a closed state of the main contacts.

In some embodiments, the auxiliary contacts are time synchronized with the moveable arm of the main contacts.

In some embodiments, the solid-state-auxiliary pair is configured to prevent electrical arcing across the first stationary contact and the first moveable contact when opening, and to reduce arcing across the second stationary contact and the second moveable contact when opening.

In some embodiments, the solid-state switch includes a drain coupled to the first terminal, a source electrode coupled to a first side of the auxiliary contacts, and a gate electrode coupled to a second side of the auxiliary contacts.

In some embodiments, a resistance of the main contacts when closed is lower than an on-resistance of the solid-state-auxiliary pair.

In some embodiments, a voltage rating of the switching system across the first and second terminal is greater than that of the main contacts.

According to some embodiments of the present disclosure, there is provided a switching system including: an electromechanical switchgear including main contacts and auxiliary contacts, the main contacts being coupled between a first terminal of the switching system and a second terminal of the switching system and configured to selectively open or close in response to a control signal; and a solid-state switch electrically connected in series with the auxiliary contacts to form a solid-state-auxiliary pair, the solid-state-auxiliary pair being coupled between the second terminal and a first moveable contact of the main contacts.

In some embodiments, the solid-state switch includes a drain electrode coupled to the second terminal, a source electrode coupled to a second side of the auxiliary contacts, and a gate electrode coupled to a first side of the auxiliary contacts.

In some embodiments, the auxiliary contacts are configured to open after a period of time in response to opening of the main contacts, and the auxiliary contacts are coupled to the main contacts and are configured to close before closing of the main contacts.

In some embodiments, the main contacts include: a first stationary contact coupled to the first terminal; a second stationary contact coupled to the second terminal; a first moveable contact and a second moveable contact; a moveable arm fixedly coupling the first and second moveable contacts and configured to move in response to the control signal.

In some embodiments, the first moveable contact and the second moveable contact are configured to contact the first stationary contact and the second stationary contact, respectively, in a closed state of the main contacts.

In some embodiments, the solid-state-auxiliary pair is configured to prevent electrical arcing across the first stationary contact and the first moveable contact when opening, and to reduce arcing across the second stationary contact and the second moveable contact when opening.

According to some embodiments of the present disclosure, there is provided a switching system including: an electromechanical switchgear including main contacts and auxiliary contacts, the main contacts being coupled between a first terminal of the switching system and a second terminal of the switching system and configured to selectively open or close in response to a control signal, and the auxiliary contacts being coupled between the second terminal and a second moveable contact of the main contacts via an RC network; and a solid-state switch electrically connected between the first terminal and the second moveable contact of the main contacts.

In some embodiments, the solid-state switch includes a drain electrode coupled to the first terminal, a source electrode coupled to second moveable contact of the main contacts, and a gate electrode coupled to the RC network.

In some embodiments, the RC network includes a first capacitor and a resistor, the first capacitor is coupled between the gate electrode of the solid-state switch and the second moveable contact of the main contacts, and the resistor is coupled between a first side of the auxiliary contacts and the gate electrode of the solid-state switch.

In some embodiments, the switching system further includes: a second capacitor coupled between the second moveable contact of the main contacts and a first side of the auxiliary contacts.

In some embodiments, the auxiliary contacts are configured to open after a period of time in response to opening of the main contacts.

In some embodiments, the main contacts include: a first stationary contact coupled to the first terminal; a second stationary contact coupled to the second terminal; a first moveable contact and a second moveable contact; a moveable arm fixedly coupling the first and second moveable contacts and configured to move in response to the control signal, wherein the first moveable contact and the second moveable contact are configured to contact the first stationary contact and the second stationary contact, respectively, in a closed state of the main contacts.

### BRIEF DESCRIPTION OF THE DRAWINGS

The accompanying drawings, together with the specification, illustrate example embodiments of the present disclosure, and, together with the description, serve to explain the principles of the present disclosure.

FIG. 1A is a schematic diagram illustrating a high-voltage electromechanical switching system, According to some embodiments of the present disclosure.

FIG. 1B is a schematic diagram illustrating an electromechanical switching system, According to some other embodiments of the present disclosure.

FIGS. 2A-2C illustrate the response of the solid-state switch to the opening of the electromechanical switchgear, which is initially in a closed state, according to some embodiments of the present disclosure.

FIGS. 3A-3C illustrate the response of the solid-state switch to the closing of the electromechanical switchgear, which is initially in an open state, according to some embodiments of the present disclosure.

FIG. 4 is a schematic diagram illustrating a high-voltage electromechanical switching system, According to some other embodiments of the present disclosure.

FIGS. 5A-5C illustrate the response of the solid-state switch to the opening of the electromechanical switchgear, which is initially in a closed state, according to some other embodiments of the present disclosure.

### DETAILED DESCRIPTION

The detailed description set forth below is intended as a description of example embodiments of a system and method for defect detection, provided in accordance with the present disclosure, and is not intended to represent the only forms in which the present disclosure may be constructed or utilized. The description sets forth the features of the present disclosure in connection with the illustrated embodiments. It is to be understood, however, that the same or equivalent functions and structures may be accomplished by different embodiments that are also intended to be encompassed within the scope of the disclosure. As denoted elsewhere herein, like element numbers are intended to indicate like elements or features.

High voltage electromechanical systems may be highly susceptible to damage during their operation. When powered components, such as contacts of a double-break switchgear, are separating from each other, an electric arc may develop across components. As a result, the material either vaporizes or transfers from one side to the other, causing deterioration and fretting of the components. In high voltage applications, this the damage to the material is more severe and of longer duration, thus reducing the life of the electromechanical system.

Accordingly, aspects of the present disclosure are directed to a switching system for protecting electromechanical switchgear in high voltage applications that includes an electromechanical switchgear with main and auxiliary contacts and a solid-state device that is coupled to the auxiliary contacts and is utilized to reduce (e.g., suppress) the fretting damage caused by arcing in high-voltage applications. In some embodiments, the switching system utilizes a simplified design that eliminates the need for a housekeeping power supply and timing circuit, reducing complexity, size, and cost. According to some embodiments, the solid-state switch is coupled to the auxiliary contacts of the electromechanical switchgear, which are physically linked to the mobile contact of the electromechanical switchgear, and protecting the contact material by effectively suppressing arcs on both input and output sides. This effectively increases the power-rating of the switching system. This design improves reliability and longevity by reducing arc duration and severity, and is versatile for various high voltage applications, such as in aircraft systems.

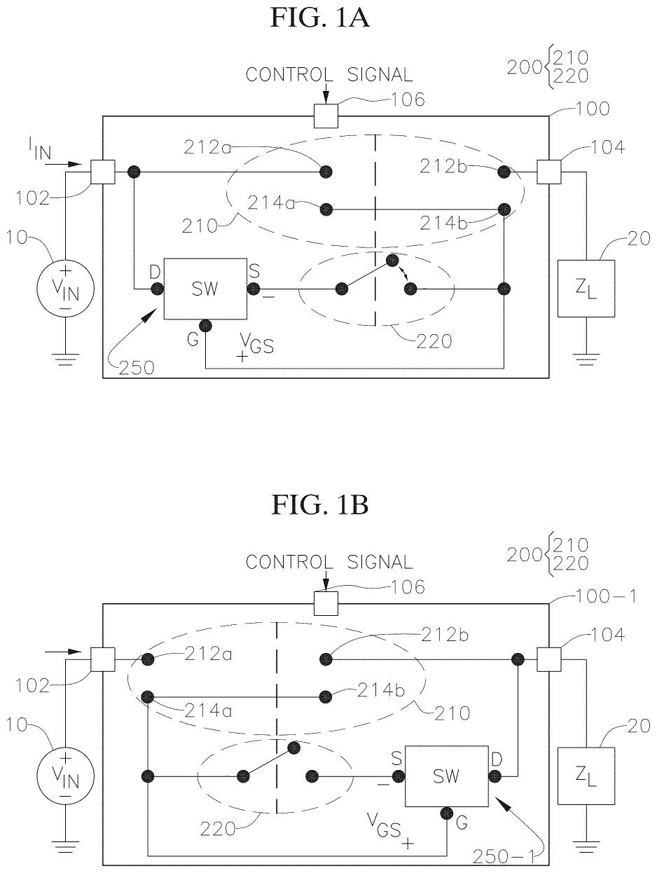

FIG. 1A is a schematic diagram illustrating a high-voltage electromechanical switching system 100, According to some embodiments of the present disclosure. FIG. 1B is a schematic diagram illustrating an electromechanical switching system 100, According to some other embodiments of the present disclosure.

Referring to FIG. 1A, the high-voltage electromechanical switching system 100 (hereinafter referred to as “switching system”) is a 3-terminal device with a first terminal (e.g., an input terminal) 102 connected to a first circuit (e.g., an input circuit) 10, a second terminal (e.g., an output terminal) 104 connected to a second circuit (e.g., an output circuit) 20, and a third terminal (e.g., a control terminal) 106 for receiving a control signal (e.g., a switch control signal). In some embodiments, the first circuit 10 may be an input power source for generating an input voltage V_{IN} and an input current I_{IN}, and the second circuit 20 may be a system load or a load circuit Z_{L}.

In some embodiments, the switching system 100 includes an electromechanical switchgear 200, which may act as a double-break contactor, and a solid-state switch 250 coupled to the electromechanical switchgear 200. The contacts of the electromechanical switchgear 200 are configured to selectively close to allow electrical current to pass through, and open to prevent passage of current through the electromechanical switchgear 200, in response to a control signal (e.g., an external control signal) V_{Control}. The electromechanical switchgear 200 may use an electromagnet to open/close the contacts of the electromechanical switchgear 200 based on the control signal V_{Control}. The electromechanical switchgear 200 includes main contacts 210 and auxiliary contacts 220 coupled to (e.g., physically linked to) the main contacts 210.

The main contacts 210 includes a pair of conductors (e.g., wires) that are separated from one another and are respectively terminated with first and second stationary contacts 212a and 212b, and further includes a moveable arm 216 with first and second moveable contacts 214a and 214b at its ends. The first and second stationary contacts 212a and 212b are coupled to (e.g., directly coupled to) the first and second terminals 102 and 104. When the main contacts 210 close in response to the control signal V_{Control} received at the third terminal 106, the moveable arm 216 moves towards the pair of conductors and the first and second moveable contacts 214a and 214b come into contact with the first and second stationary contacts 212a and 212b, respectively, and establishes a current path between the first and second terminals 102 and 104.

The auxiliary contacts 220 may be physically linked to the main contacts 210, for example, via the contactor shaft 230, and are time synchronized such as when the main contacts 210 open or close in response to the control signal V_{Control} at the third terminal 106, the auxiliary contacts 220 also concurrently open or close in a time-synchronized fashion. In some embodiments, the solid-state switch 250 is electrically connected in series with the auxiliary contacts 220 to form a solid-state-auxiliary pair, which is coupled between the first terminal 102 and the second moveable contact 214b of the main contacts. That is, a first end of the auxiliary contacts 220 is connected to the solid-state switch 250 and the second end of the auxiliary contacts 220 is connected to the moveable arm 216 of the main contacts 210.

As shown in FIG. 1A, in some embodiments, the solid-state switch 250 may include an n-type transistor, such as an n-channel metal-oxide semiconductor, an n-channel JFET, or the like. The solid-state switch 250 may include a drain electrode connected to the first terminal 102, a source electrode connected to the first end of the auxiliary contacts 220, and a gate electrode connected to the second end of the auxiliary contacts 220 and the second moveable contact 214b. In such arrangements, the solid-state switch 250 operates as a voltage-controlled device that is activated (e.g., turned ON) when the gate-source voltage V_{GS} is at about 0 V, and is deactivated (e.g., turned OFF) when a voltage with proper polarity is applied between the gate G and source S terminals of the solid-state switch 250. Thus, as shown in FIG. 1A, the solid-state switch 250 is deactivated when the auxiliary contacts 220 are open (e.g., when the main contacts 210 are open), and is activated (e.g., is only activated) when the auxiliary contacts 220 are closed (e.g., when the main contacts 210 are closed).

Referring now to FIG. 1B, in some embodiments, the solid-state switch 250-1 includes a p-channel transistor, such as an p-channel metal-oxide semiconductor, a p-channel JFET, or the like. The solid-state switch 250-1 may include a drain electrode connected to the second terminal 104, a source electrode connected to the second end of the auxiliary contacts 220 and a gate electrode connected to the first end of the auxiliary contacts 220 and the first moveable contact 214a. Here, the solid-state switch 250-1 is activated (e.g., turned ON) when the gate-source voltage V_{GS} is at about 0 V, and is deactivated (e.g., turned OFF) when the gate-source voltage V_{GS} becomes positive. Thus, as shown in FIG. 1B, the solid-state switch 250-1 is deactivated when the auxiliary contacts 220 are open (e.g., when the main contacts 210 are open), and is activated (e.g., is only activated) when the auxiliary contacts 220 are closed (e.g., when the main contacts 210 are closed).

As will be understood by a person of ordinary skill in the art, while the solid-state switch 250/25-1 includes drain, source, and gate electrodes, embodiments of the present disclosure are not limited thereto. For example, the solid-state switch 250 may be replaced with any suitable type of electronic switch.

The following description will primarily focus on the operation of the electromechanical switching system 100 of FIG. 1A, which utilizes an n-channel JFET. However, the operational concepts described below are equally applicable to electromechanical switching system 100-1 of FIG. 1B, which utilizes a p-channel JFET. As such, the description of the operation of the latter system will not be repeated below.

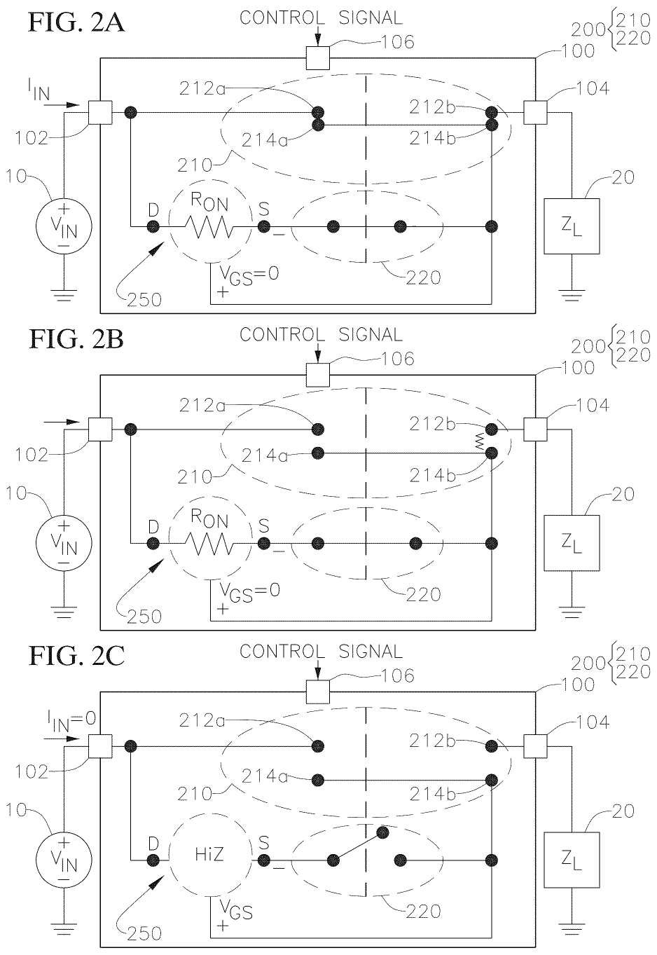

FIGS. 2A-2C illustrate the response of the solid-state switch 250 to the opening of the electromechanical switchgear 200, which is initially in a closed state, according to some embodiments of the present disclosure.

Referring to FIG. 2A, when the electromechanical switchgear 200 is initially closed, both the main contacts 210 and the auxiliary contacts 220 are closed, and the voltage drop across the auxiliary contacts 220 is substantially zero, which causes the solid-state switch 250 to be activated (e.g., turned ON) because the gate-source voltage V_{GS} is at about 0 V. Here, the solid-state switch 250 may be represented with a small on-resistance R_{ON}. In some examples, the on-resistance R_{ON} of the solid-state switch 250 may be about 25 mΩ, which may be similar to the on-resistance of the auxiliary contacts 220. However, when closed, the main contacts 210 may have a substantially lower on-resistance of, for example, about 0.7 mΩ. Thus, in this state, only 2-3% of the current flowing through the first and second terminals 102 and 104 of the switching system 100 may flow through the solid-state switch 250. This allows the switching system 100 to utilize a small and low cost solid-state device even in high current conditions (e.g., 100 A to 400 A), which reduces the overall size and cost of the switching system 100.

As shown in FIG. 2B, when an appropriate control signal is applied to the control terminal 106 of the switching system 100 to open the electromechanical switchgear 200, because of the small time delay between the opening of the main contacts 210 and the auxiliary contacts 220, the main contacts 210 may open first while the auxiliary contacts 220 are initially closed. At this point, the solid-state switch 250 is still activated and the voltage drop across the first stationary and moveable contacts 212a and 214a is initially negligible (e.g., about 0 V) and when main contacts 210 start to open it causes the arc on the input/output side of the main contacts 210 (e.g., across the first stationary and moveable contacts 212a and 214a) to be quenched almost immediately. However, an electrical arc may appear at the output side of the main contacts (i.e., across the second stationary and moveable contacts 212b and 214b).

Referring to FIG. 2C, a short period of time (e.g., less than 1 ms) after the opening of the main contacts 210, the auxiliary contacts 220 also open, which causes the solid-state switch 250 to deactivate. This eliminates the current path between the first terminal 102 and the second moveable contact 214b, which quenches the arc across the output side of the main contacts 210 (i.e., across the second stationary and moveable contacts 212b and 214b).

This control mechanism is achieved by the (built in) delay between the opening of the main contacts 210 and the auxiliary contacts 220. This delay may not be too short in order to provide sufficient time for an airgap to be created when the main contacts 210 are opening, and may not be too long as it is desirable for reduce (e.g., minimize) the duration of time that the arc persists (i.e., it is desirable to extinguish the arc as quickly as possible). In some examples, the delay between the opening of the main contacts 210 and the auxiliary contacts 220 may be set to about 200 μs to about 500 μs, depending on the maximum current and the maximum voltage that the electromechanical switching system 100 is designed for and the maximum air gap between the main contacts 210 when open (which may be small for a switching system 100 that is about 1 in by 1 in in size). However, depending on manufacturing deviations may bring this to 100 μs to about 3 ms in a commercial product.

Due to how quickly the solid-state switch 250 is able to extinguish the arc at the main contacts 210 upon opening, the arc is not able to deliver a large amount of energy, which significantly reduces (e.g., minimizes) the damage to the main contacts 210. As a result, the lifespan of the switching system 100 may be about 50,000 cycles, which is significantly greater than the 2000 to 3000 cycle lifespan of an electromechanical switchgear of the related art. The longer lifespan can significantly reduce the replacement cost of the contactor.

Further, because the impedance of the solid-state switch 250 in the deactivated state (i.e., its off-resistance) and the voltage rating of the solid-state switch 250 are substantially higher than those of the electromechanical switchgear 200, the negative feedback behavior inherent in the solid-state switch 250 may limit the amount of voltage across the main contact 210 and auxiliary contacts 220 of the electromechanical switchgear 200 to a gate-source off-voltage V_{GSOFF}. Thus, in addition to protecting the main contacts 210, the solid-state switch 250 is capable of protecting the auxiliary contacts 220 against fretting and sustained arcing.

Furthermore, when the electromechanical switchgear 200 is open, the leakage current of the solid-state switch 250 is blocked, and the galvanic isolation of the switchgear 200 is maintained.

In some examples, the solid-state switch 250/250-1 may be rated for up to 1200 V to accompany and enhance a low-voltage electromechanical switchgear 200 that is rated at 28 V to be used in 100 V or above applications.

While the arc-quenching effect of the present disclosure is most pronounced during the opening of the electromechanical switchgear 200, for the sake of completeness, the operation of the electromechanical switching system 100 during the closing operation of the switchgear 200 is described below.

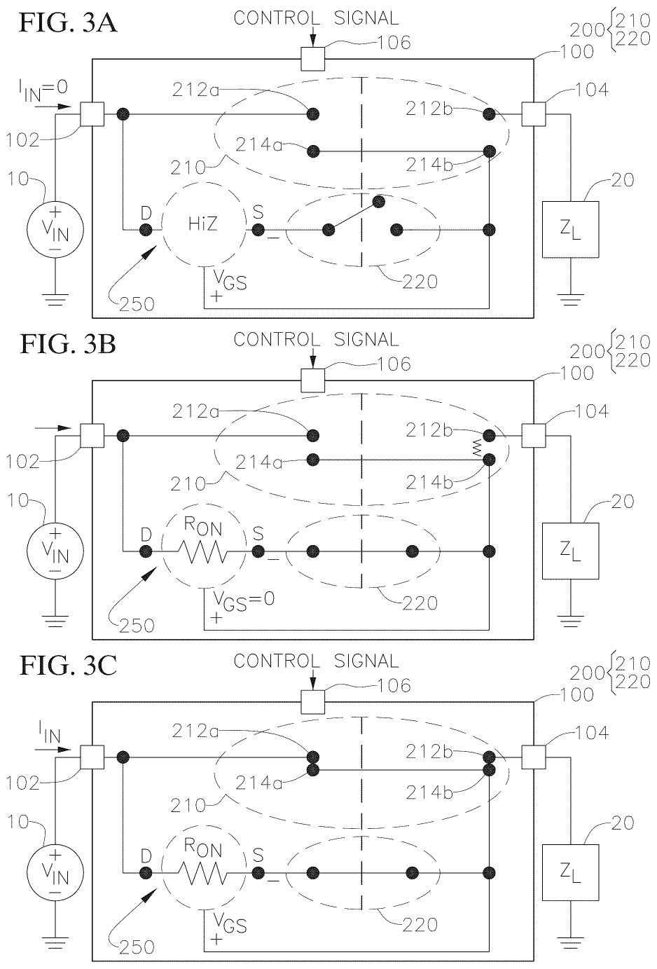

FIGS. 3A-3C illustrate the response of the solid-state switch 250 to the closing of the electromechanical switchgear 200, which is initially in an open state, according to some embodiments of the present disclosure.

Referring to FIG. 3A, when the electromechanical switchgear 200 is initially open, the auxiliary contacts 220 are open and the solid-state switch 250 is deactivated and in a high-impedance state.

As shown in FIG. 3B, when an appropriate control signal is applied to the control terminal 106 of the electromechanical switching system 100 to close the electromechanical switchgear 200, the auxiliary contacts 220 close (e.g., slightly before or after) the main contacts 210, which causes the solid-state switch 250 to activate (i.e., turn ON). This creates a low-resistance path between the first terminal 102 and the moveable arm 216 and reduces the voltage drop across the input side of the main contacts 210 (i.e., across the first stationary and moveable contacts 212a and 214a), which prevent an arc from being created at the input side when the main contacts 210 close.

Shortly thereafter (e.g., within a few microseconds), as shown in FIG. 3C, the main contacts 210 fully close thus quickly extinguishing any arc that may exist at the output end of the main contacts 210 (i.e., across the second stationary and moveable contacts 212b and 214b). Due to how quickly the main contacts 210 close, the amount of energy passing through the air gap between the main contacts as they come to a close may be negligible, and thus damage to the main contacts 210 may be avoided.

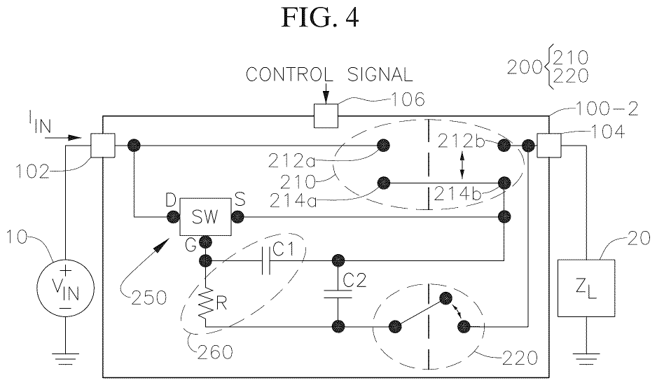

FIG. 4 is a schematic diagram illustrating a high-voltage electromechanical switching system 100-2, According to some embodiments of the present disclosure. Here, many of the components of the switching system 100-2 and their corresponding functions and operations may be the same or substantially the same as those of the switching system 100 described with reference to FIG. 1A. Thus, for purposes of clarity and brevity of description, the following will primarily focus on the aspects of the switching system 100-2 that are different from the switching system 100.

Referring to FIG. 4, in some embodiments, the solid-state switch 250 of the switching system 100-2 is coupled between (e.g., directly coupled between) the first terminal 102 and the second moveable contact 214b of the main contacts 210. Further, the auxiliary contacts 220 are coupled between the second terminal 104 and one end of a resistor R. The other end of the resistor R is coupled to the gate electrode of the solid-state switch 250. A first capacitor (e.g., a timing capacitor) C1 is coupled between the second moveable contact 214b of the main contacts 210 and the gate electrode of the solid-state switch 250. The first capacitor C1 and the resistor R together make up an RC network 260. In some examples, a second capacitor (e.g., an energy storage capacitor) C2 is coupled between the second moveable contact 214b of the main contacts 210 and the side of the auxiliary contacts 220 not directly connected to the second terminal 104.

In the switching system 100 of FIG. 1A, the auxiliary contacts 220, which provide a control mechanism to switch off the solid-state switch 250, are connected in series with the solid-state switch 250 and may thus carry a current corresponding to the load current (e.g., may carry a current that is about 6% to about 100% of the load current). In contrast, in the switching system 100-2 of FIG. 4, because the auxiliary contacts 220 are not connected in series with the solid-state switch 250, the auxiliary contacts 220 conduct small amounts of current over short period of time (e.g., a few microseconds, such as 3 μs to 5 μs) when closed, and zero amps when open. Further, in the switching system 100-2 of FIG. 4 the auxiliary contacts 220 provide the control mechanism for controlling the on/off state of the solid-state switch 250 in conjunction with the RC network 260 and the second capacitor C2.

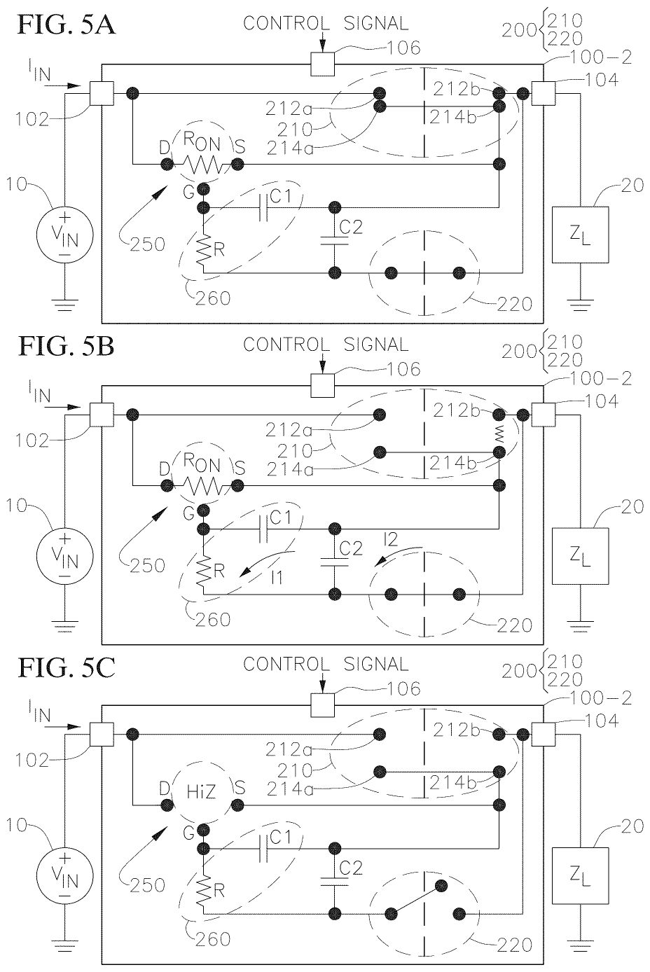

According to some embodiments, the RC network 260 allows for precise control of the duration of the arcing time, and the presence of the second capacitor C2 decouples the timing of the opening of the auxiliary contacts 220 and the opening of the solid-state switch 250, as will be described in further detail with respect to FIGS. 5A-5C.

FIGS. 5A-5C illustrate the response of the solid-state switch 250 to the opening of the electromechanical switchgear 200 of the switching system 100-2, which is initially in a closed state, according to some embodiments of the present disclosure.

Referring to FIG. 5A, when the electromechanical switchgear 200 of the switching system 100-2 is initially closed, both the main contacts 210 and the auxiliary contacts 220 are closed, and the voltage across the capacitor C is also zero, which leads to the solid-state switch 250 being activated (e.g., turned ON; as represented by the small on-resistance R_{ON}).

As shown in FIG. 5B, when an appropriate control signal is applied to the control terminal 106 of the switching system 100 to open the electromechanical switchgear 200, because of the small time delay between the opening of the main contacts 210 and the auxiliary contacts 220, the main contacts 210 may open first while the auxiliary contacts 220 are initially closed. At this point, the solid-state switch 250 is still activated and the voltage drop across the first stationary and moveable contacts 212a and 214a is initially negligible (e.g., about 0 V) and when main contacts 210 start to open it causes the arc on the input/output side of the main contacts 210 (e.g., across the first stationary and moveable contacts 212a and 214a) to be quenched almost immediately. However, an electrical arc may appear at the output side of the main contacts 210 (i.e., across the second stationary and moveable contacts 212b and 214b). The electrical arc at the output side of the main contacts 210 dissipates into the RC network 260 and the second capacitor C2, which are coupled in parallel. The charge build up across the first capacitor C1 over time, increases the voltage drop across the gate and source electrodes of the solid-state switch 250.

In some embodiments, the second capacitor C2 may be significantly larger than (e.g., an order of magnitude larger than) the first capacitor, and thus capable of storing more energy than the first capacitor C1. For example, the first capacitance may be about 33 nF while the second capacitance may be about 330 nF. The resistor R may be relatively large (e.g., about 10 KΩ), and limits the inrush current I1 through the first capacitor C1 (in particular relative to the inrush current I2 passing through the second capacitor C2). As a result, most of the arc energy may be dissipated through (and stored in) the second capacitor C2 while the auxiliary contacts are still in a closed state.

Referring to FIG. 5C, a short period of time (e.g., a few tens or hundreds of microseconds) after the opening of the main contacts 210, the auxiliary contacts 220 also open, which prevents further charging of the second capacitor C2. However, given the parallel connection of the second capacitor C2 and the RC network 260, the charge stored at the second capacitor C2 may continue to charge the first capacitor C1 and drive up the voltage drop across the first capacitor C1 and the source and gate electrodes of the solid-state switch 250. Once the voltage drop reaches the gate-source off-voltage V_{GSOFF} of the solid-state switch 250, the switch 250 deactivates (e.g., turns OFF). This eliminates the current path between the first terminal 102 and the second moveable contact 214b, which quenches the arc across the output side of the main contacts 210 (i.e., across the second stationary and moveable contacts 212b and 214b). As described, in some examples, the solid-state switch 250 may deactivate after the opening of the auxiliary contacts 220; however, embodiments of the present disclosure are not limited thereto, and depending on the capacitance and resistance values of the RC network 260 and the opening delay between the main contacts 210 and the auxiliary contacts 220, the solid-state switch 250 may deactivate before or after the auxiliary contacts 220. Here, the decoupling of the opening times of the solid-state switch 250 and the auxiliary contacts 220 is achieved by the presence of the second capacitor (e.g., energy storage capacitor) C2, which stores much of the arc energy. Due to this decoupling, the timing delay between the main and auxiliary contacts 210 and 220 is less critical, which simplifies the implementation of the switching system 100-2, eases manufacturing tolerances, and improves the overall reliability of the product.

As described above, by reducing (e.g., minimizing) the duration and severity of the electric arc at the switchgear contacts, the switching system according to some embodiments significantly reduces the fretting and deterioration of the contact material, thereby extending the life of the electromechanical switchgear, improving overall system reliability, and reducing the cost of deploying the electromechanical switching system in power distribution systems.

Further, by utilizing the auxiliary contacts of the electromechanical switchgear that are time-synchronized with the main contacts to provide passive and automatic control of the solid-state switch, the switching system eliminates the need for the housekeeping power supply and the timing circuit of the related art and does not require any other active control circuitry for controlling the on/off state of the solid-state device. This greatly simplifies the complexity, size (e.g., footprint), and cost of the system.

Furthermore, the relatively small-footprint and relatively high voltage rating of the solid-state device allows the electromechanical switching system to be utilized in space-constrained and high voltage applications including those in aircrafts, where the trend is moving towards higher DC voltages.

Additionally, the solid-state device allows a low-voltage rating switchgear (e.g., with a rating of 28 V) to be used in a high-voltage application (e.g., a 270 V application), thus effectively increasing the power-rating of the electromechanical switching system. As the size and cost of the switchgear can significantly increase for higher voltage ratings, by utilizing the solid-state device, the electromechanical switching system may provide the performance of a high-voltage rating switchgear of the related art, but at a fraction of the footprint and cost of the related art solutions.

The terminology used herein is for the purpose of describing particular embodiments and is not intended to be limiting of the inventive concept. As used herein, the singular forms “a” and “an” are intended to include the plural forms as well, unless the context clearly indicates otherwise. It will be further understood that the terms “include”, “including”, “comprises”, and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of”, when preceding a list of elements, modify the entire list of elements and do not modify the individual elements of the list. Further, the use of “may” when describing embodiments of the inventive concept refers to “one or more embodiments of the inventive concept”. Also, the term “exemplary” is intended to refer to an example or illustration.

It will be understood that, although the terms “first”, “second”, “third”, etc., may be used herein to describe various elements, components, and/or sections, these elements, components, and/or sections should not be limited by these terms. These terms are used to distinguish one element, component, or section from another element, component, or section. Thus, a first element, component, or section discussed below could be termed a second element, component, or section, without departing from the scope of the inventive concept.

It will be understood that when an element is referred to as being “connected to” or “coupled to” another element, it can be directly connected to or coupled to the other element, or one or more intervening elements may be present. When an element is referred to as being “directly connected to” or “directly coupled to” another element, there are no intervening elements present.

As used herein, the terms “use”, “using”, and “used” may be considered synonymous with the terms “utilize”, “utilizing”, and “utilized”, respectively.

While this disclosure has been described in detail with particular references to illustrative embodiments thereof, the embodiments described herein are not intended to be exhaustive or to limit the scope of the disclosure to the exact forms disclosed. Persons skilled in the art and technology to which this disclosure pertains will appreciate that alterations and changes in the described structures and methods of assembly and operation can be practiced without meaningfully departing from the principles, and scope of this disclosure, as set forth in the following claims and equivalents thereof.

What is claimed is:

1. A switching system comprising:
an electromechanical switchgear comprising main contacts and auxiliary contacts, the main contacts being coupled between a first terminal of the switching system and a second terminal of the switching system and configured to selectively open or close in response to a control signal; and
a solid-state switch electrically connected in series with the auxiliary contacts to form a solid-state-auxiliary pair, the solid-state-auxiliary pair being coupled between the first terminal and a second moveable contact of the main contacts.

2. The switching system of claim 1, wherein the auxiliary contacts are configured to open after a period of time in response to opening of the main contacts.

3. The switching system of claim 2, wherein the period of time is about 100 μs to about 3 ms.

4. The switching system of claim 1, wherein a gate of the solid-state switch is electrically connected to the second moveable contact of the main contacts, and
wherein the first terminal is coupled to a power source, and the second terminal is coupled to a load circuit.

5. The switching system of claim 1, wherein the main contacts comprise:
a first stationary contact coupled to the first terminal;
a second stationary contact coupled to the second terminal;
a first moveable contact and a second moveable contact;
a moveable arm fixedly coupling the first and second moveable contacts and configured to move in response to the control signal.

6. The switching system of claim 5, wherein the first moveable contact and the second moveable contact are configured to contact the first stationary contact and the second stationary contact, respectively, in a closed state of the main contacts, and
wherein the auxiliary contacts are time synchronized with the moveable arm of the main contacts.

7. The switching system of claim 5, wherein the solid-state-auxiliary pair is configured to prevent electrical arcing across the first stationary contact and the first moveable contact when opening, and to reduce arcing across the second stationary contact and the second moveable contact when opening.

8. The switching system of claim 1, wherein the solid-state switch comprises a drain electrode coupled to the first terminal, a source electrode coupled to a first side of the auxiliary contacts, and a gate electrode coupled to a second side of the auxiliary contacts.

9. The switching system of claim 1, wherein a voltage rating of the switching system across the first and second terminal is greater than that of the main contacts.

10. A switching system comprising:
an electromechanical switchgear comprising main contacts and auxiliary contacts, the main contacts being coupled between a first terminal of the switching system and a second terminal of the switching system and configured to selectively open or close in response to a control signal; and
a solid-state switch electrically connected in series with the auxiliary contacts to form a solid-state-auxiliary pair, the solid-state-auxiliary pair being coupled between the second terminal and a first moveable contact of the main contacts.

11. The switching system of claim 10, wherein the solid-state switch comprises a drain electrode coupled to the second terminal, a source electrode coupled to a second side of the auxiliary contacts, and a gate electrode coupled to a first side of the auxiliary contacts.

12. The switching system of claim 10, wherein the auxiliary contacts are configured to open after a period of time in response to opening of the main contacts.

13. The switching system of claim 10, wherein the main contacts comprise:
a first stationary contact coupled to the first terminal;
a second stationary contact coupled to the second terminal;
a first moveable contact and a second moveable contact;
a moveable arm fixedly coupling the first and second moveable contacts and configured to move in response to the control signal.

14. The switching system of claim 13, wherein the first moveable contact and the second moveable contact are configured to contact the first stationary contact and the second stationary contact, respectively, in a closed state of the main contacts, and
wherein the solid-state-auxiliary pair is configured to prevent electrical arcing across the first stationary contact and the first moveable contact when opening, and to reduce arcing across the second stationary contact and the second moveable contact when opening.

15. A switching system comprising:
an electromechanical switchgear comprising main contacts and auxiliary contacts, the main contacts being coupled between a first terminal of the switching system and a second terminal of the switching system and configured to selectively open or close in response to a control signal, and the auxiliary contacts being coupled between the second terminal and a second moveable contact of the main contacts via an RC network; and
a solid-state switch electrically connected between the first terminal and the second moveable contact of the main contacts.

16. The switching system of claim 15, wherein the solid-state switch comprises a drain electrode coupled to the first terminal, a source electrode coupled to second moveable contact of the main contacts, and a gate electrode coupled to the RC network.

17. The switching system of claim 16, wherein the RC network comprises a first capacitor and a resistor,
wherein the first capacitor is coupled between the gate electrode of the solid-state switch and the second moveable contact of the main contacts, and
wherein the resistor is coupled between a first side of the auxiliary contacts and the gate electrode of the solid-state switch.

18. The switching system of claim 15, further comprising:
a second capacitor coupled between the second moveable contact of the main contacts and a first side of the auxiliary contacts.

19. The switching system of claim 15, wherein the auxiliary contacts are configured to open after a period of time in response to opening of the main contacts.

20. The switching system of claim 15, wherein the main contacts comprise:
a first stationary contact coupled to the first terminal;
a second stationary contact coupled to the second terminal;
a first moveable contact and a second moveable contact;
a moveable arm fixedly coupling the first and second moveable contacts and configured to move in response to the control signal,
wherein the first moveable contact and the second moveable contact are configured to contact the first stationary contact and the second stationary contact, respectively, in a closed state of the main contacts.
